(19) United States
(12) Patent Application Publication
(10) Pub. No.: US 2017/0076076 A1
(43) Pub. Date: Mar. 16, 2017

(54) Biometric Mobile Authentication for Real-Time Communications

(71) Applicant: SecureLogix Corporation, San Antonio, TX (US)

(72) Inventors: Jacek Materna, San Antonio, TX (US); Mark Collier, Austin, TX (US)

(73) Assignee: SecureLogix Corporation, San Antonio, TX (US)

(21) Appl. No.: 15/263,047

(22) Filed: Sep. 12, 2016

Related U.S. Application Data
(60) Provisional application No. 62/216,500, filed on Sep. 10, 2015.

(51) Int. Cl. G06F 21/32; G06Q 20/40; H04L 29/06; H04W 12/06; G06F 21/62

(52) U.S. Cl. CPC G06F 21/32; H04W 12/06; G06F 21/6245; H04L 63/0861; G06Q 20/40145

(57) ABSTRACT

The present invention relates to systems and methods that authenticate a user and a mobile device via the mobile device. The systems and methods utilize biometric data for authenticating a user and a mobile device in a network-based environment during a real-time communications session with other network elements and applications.

### NON-PROVISIONAL PATENT APPLICATION

This is a Non-Provisional patent application filed under 37 CFR 1.53(b) and is submitted with an accompanying non-publication request in accordance with 35 U.S.C. §122(b). Accordingly, the subject matter of this application is to be maintained in secrecy until and unless Applicant allows a patent to issue based on this application.

### CLAIM OF PRIORITY TO PRIOR APPLICATION

This application claims the benefit of the filing date of U.S. Provisional Application, Ser. No. 62/216,500, filed on Sep. 10, 2015. By this reference, the entire disclosure, including the claims and drawings, of U.S. Provisional Application, Ser. No. 62/216,500, is incorporated herein as though now set forth in its entirety.

### BACKGROUND OF THE INVENTION

1. Technical Field

The disclosure relates generally to authentication of users and mobile devices in a network-based environment for the purpose of either validating or repudiating those mobile devices and users during real-time transactions with other network elements and applications.

2. Description of Related Art

Authenticating users via their mobile device is becoming more important as applications and services can no longer rely on authenticating the user using traditional methods alone. Due to technology proliferation, it has become increasingly easy to overcome existing authentication methods, which rely on properties that can be easily broken. There are four categories of authentication methods, each carrying its own properties. These four categories and their properties are the following:
1. Knowledge-based Authentication Methods (What the user knows)
   a. Examples include: User ID, password, and Personal Identification Number (PIN)
   b. Properties include: can be shared, easily guessed or forgotten
2. Token-based Authentication Methods (What the user has)
   a. Examples include: magnetic or electronic cards, badges, keys
   b. Properties include: can be shared, duplicated, lost, or stolen
3. Knowledge-based plus Token-based Authentication Methods (What the user knows plus what the user has)
   a. Examples include: Automated Teller Machine (ATM) card plus PIN
   b. Properties include: can be shared, PIN is a weak link (for example, users may write the PIN on the card)
4. Biometric-based Authentication Methods (Something unique to the user)
   a. Examples: Physical biometrics include fingerprints; hand or palm geometry; retina, iris or facial characteristics; voice print; and DNA. Behavioral biometrics include signature, keystroke pattern, and gait.
   b. Properties include: not possible to share, repudiation unlikely, not easily forged, cannot be lost or forgotten.

Currently, authentication solutions exist in all four categories. Unfortunately, they fail to address the emerging need for localized privacy and mass-market ease of use. This is unfortunate because the public is becoming increasingly aware of not only the vulnerability of their own mobile devices but also the vulnerability of their private information on the networks and servers belonging to major corporations and governments. For example, events where sensitive information is divulged by individuals trusted to maintain its confidentiality, breaches of major corporate databases where customers' identities and confidential information is stolen and exploited, and occurrences of state-sponsored hacking are becoming increasingly commonplace. Although the effort required to enable defenses against such attacks is high, the effort required to breach these defenses is relatively low. Hackers are finding ways around defensive measures, attacking weak points, and gathering personal information.

Coupled with the increasing vulnerabilities described above, there has been an explosive increase in the number of mobile devices, such that by some estimates, there were approximately 4 billion mobile devices worldwide in 2015. This number is projected to reach 5 billion by 2020. Mobile devices have become essential tools with which users conduct many personal and confidential tasks on a daily basis, including financial transactions, personal communication, recording personal data, medical scheduling, and various other transactions that require private and sensitive information to be used or exchanged with other parties over public and private networks. Specifically, many of these daily tasks involve Real-Time Communications (RTC). RTC encompasses all forms of communication where a user is in an active session with another user including, but not limited to, Web RTC, Short Message Service (SMS), phone calls, and over-the-top (OTT) content services such as Skype or Facebook.

The ever-increasing number and usefulness of mobile devices positions two competing needs on a collision course: the user's need to access anything, anytime, and anywhere on a mobile device and the need to ensure that user information is secured and private. This dichotomy creates a strong need for a process to authenticate users during their anything, anytime, and anywhere transaction on their devices, while at the same time ensuring private information stays private and stays localized to those devices.

Currently, several methods exist for employing biometric data to authenticate a mobile device user. These methods rely on various biometric techniques for authenticating the mobile device, the user, or both the mobile device and the user. Unfortunately, the existing methods all fail to provide both localized privacy and a seamless user experience. The mass-market adoption of the authentication process disclosed herein is directly coupled with the user experience, in that a seamless, transparent approach will win over the mass market as opposed to complex and non-intuitive approaches. History proves that simple solutions win over convoluted strategies.

As an example, many existing technologies attempt to authenticate a caller, particularly in connection with financial contact centers. Financial organizations commonly use Knowledge-Based Authentication (KBA), which are not considerably effective, as referenced above. Financial institutions may also employ technologies such as voice authentication, including active and passive versions. These technologies tend to be expensive, affect the customer's experience, locally save a voice print, along with other drawbacks. Additionally, financial organizations are also beginning to make use of network-based queries which determine if a user's device is actually engaged in a call with a contact center. Such systems do not authenticate the individual, just that the user's device is actually making the call. Moreover, these queries typically have costs per call, introduce delays, and may require complex integration.

In addition to the above-identified authentication methods, financial institutions are also pursuing employment of mobile applications, which often have a “talk to agent” feature incorporated therein. Although a user of such a mobile application of a financial institution has likely already been authenticated in order to use the application, the mechanisms for this type of authentication are often complex. However, a certain number of users do not and/or will not use a financial institution's mobile application. Thus, solutions for authenticating all such users and devices in real-time communications sessions are needed.

### SUMMARY OF THE INVENTION

The present disclosure uses biometric authentication methods to address the challenges of mobile device authentication, the lack of localized privacy, and a seamless user experience. The present disclosure uses local biometric authentication to tie a user to a mobile device for a given transaction. Specifically, during a given transaction event, the authentication consumer knows whether the user and the mobile device are co-located. Being able to tie a user to a mobile device during a particular transaction is critical in preventing fraud and identity-related issues for transactions. Use of knowledge-based authentication methods (i.e., User ID, password, PIN) between parties in a transaction has been proven to be unreliable because the data can be impersonated and/or spoofed. Rather, a trusted, time-based tie between the user, the mobile device, and the transaction must be established. The present disclosure combines a seamless user experience with localized privacy biometrics on mobile devices with a public network cloud when engaging in a transaction with that user on that mobile device in a given time window.

Localized privacy is a critical facet of the adoption of the authentication process disclosed herein, in that today's privacy-sensitive user will not accept a strategy where the user's private information is stored outside of the user's mobile device. More particularly, users find it unacceptable to store some derivation or copy of their biometric data on an external system for the purpose of enabling a remote authentication process. This strongly felt opinion is hardly surprising. Since the biometric authentication identifies the user personally, the user's biometric data does not change over time, and if a user's biometric data is ever stolen or compromised, it is potentially comprised forever. The present disclosure builds on the two axioms of localized privacy and a seamless user experience to establish differentiation form current solutions.

The present authentication process differs from current solutions in that it provides a method for a transparent user experience to the authentication process. Moreover, the process takes advantage of vendor biometric hardware or software that comes standard with the mobile device, thereby avoiding any expenditure by the user in order to benefit from the present authentication process.

The present disclosure enables solutions that use the ubiquitous biometric system hardware or software that is on every mobile device to provide a seamless user experience. More particularly, steps in which the user (1) touches an icon to initiate the authentication process and the subsequent real-time communications session, and (2) interacts in the local biometric authentication process, are both familiar operations for the user of the mobile device prior to participating in the authentication process.

The present disclosure provides a seamless user experience in that all steps and processes, other than the two steps just described above, are transparent to the user and take place so quickly that the user remains unaware that any operations occur after the local biometric authentication process and before the user becomes aware of the real-time communication session being established with the authentication consumer.

The present disclosure differs from and improves upon current solutions in that it provides localized privacy of the highly confidential user biometric data by using the biometric arbitration result as user biometric metadata, thereby allowing the highly confidential user biometric data to remain within the physical boundary of the biometric authentication system. Simply put, the user's biometric data does not leave the mobile device and is never sent to nor is exchanged with any external parties. Localized privacy is extremely important for large, wide-scale adoption in a privacy-sensitive world. Sending data such as a digital signature of a person's face photo or biometric data to an external party for comparison with a database of signatures breaks this charter. More particularly, by linking the mobile device to an external server, a coupling of the two systems is created whereby the privacy boundary extends over a public network(s), especially given that such network(s) can be compromised. Moreover, the scalability implications of relying on a central server to participate in this process are difficult to manage from a large-scale, multi-hundred million mobile device application perspective.

Still further, the present disclosure differs from current solutions in that it defines an interface with the authentication consumer that is decoupled from that with the mobile device and user. The authentication consumer operates on metadata that is not directly representative of the user's confidential biometric data. This metadata serves only as the vehicle for tying information the authentication consumer sees in real time to a state or set of states against the mobile device and the user. This decoupling provides protection for the user's confidential biometric data, while at the same time the device metadata is flexible enough that it can contain data from an unbounded set of consumer requirements. Device metadata includes, but is not limited to, the user's Subscriber Identity Module (SIM) phone number provisioned on the device, and unique hardware identifiers, such as a MAC address for more generic transactions.

The present disclosure also differs from current solutions in that it provides a cloud element on a server on a public network(s) to serve as a broker of the metadata between authentication consumers and users/mobile devices. The cloud element manages transient metadata and exposes the metadata to the authentication consumer asynchronously without user guidance or connectivity to the mobile device. The cloud element decouples the mobile device from the authentication consumer, thereby completely obfuscating the authenticated party in either direction. In other words, the authentication consumer does not know anything other than the metadata it sees in real time in terms of a relationship to the source mobile device/user, and the mobile device/user does not have visibility into how the metadata is consumed (when, how, why, etc.).

The present disclosure has advantages over current solutions. For example, providing biometric authentication using built-in vendor hardware is advantageous in that it does not introduce additional financial expense to the user, or another or adjunct piece of hardware to the user's mobile device. This directly translates to a lower barrier to adoption of the authentication methods disclosed herein, since the biometric system is included in the mobile device purchase and works out-of-the-box, without requiring the user install additional equipment.

Another advantage over current solutions is that the present systems and methods provide local privacy in that the user's highly confidential biometric data never leaves the biometric authentication system of the mobile device. Mobile device vendors aligning with local privacy have a vested interest in keeping this data protected and local. No version, copy, or derivation of the user's biometric data is ever exported outside the boundary of the mobile device. More particularly, the user's biometric data remains within the physical boundary of the mobile device biometric authentication system and secret from the authentication process at all times.

Still another advantage over current solutions is that the disclosed systems and methods provide a cloud element for storing transient metadata during a transaction time window for eventual use by the authentication consumer when participating in a transaction with a user on the user's mobile device. The cloud element solely determines what to do with the metadata and how it is presented to an authentication consumer, independent of the mobile device and user in question. This reinforces the aforementioned separation differentiation.

Also, as previously mentioned, the disclosed systems and methods provide a consumer-grade user experience in that the authentication process follows the accepted way users interact with biometric hardware and software on their mobile devices.

A preferred embodiment includes a central authentication system using local biometric authentication of a user via a mobile device to centrally authenticate the user and the mobile device during a real-time communications session. The central authentication system includes an authentication application which is configured to initiate a local biometric authentication of the user by a biometric authentication system within the mobile device, wherein the user biometric data created by the biometric authentication system remains secret from the central authentication system and within the biometric authentication system physical boundary at all times. The authentication application further receives user biometric metadata, extracts authentication metadata. The authentication metadata includes at least one metadata selected from a group of metadata including, but not limited to, a phone number and a media access control (MAC) address. The authentication application is further configured to push the authentication metadata to a cloud element, and to prompt the mobile device to establish the real-time communication session with an authentication consumer. The cloud element is configured to: (1) store the authentication metadata; (2) receive a query containing real-time communications metadata extracted from the real-time communications session with the authentication consumer; (3) compare the real-time communications metadata to the authentication metadata; and (4) present a central authentication result to the authentication consumer. In preferred embodiments, the real-time communications metadata includes at least one metadata selected from a group of metadata including, but not limited to, a phone number and a MAC address.

Preferred embodiments include a method for centrally authenticating both a mobile device and a user during a real-time communications session. The method includes initiating a local biometric authentication of the user, wherein user biometric data created during the local biometric authentication of the user remains secret from the method for centrally authenticating at all times. A preferred method further includes receiving user biometric metadata from a biometric authentication system, wherein the user biometric metadata indicates a local authentication posture of the user. Authentication metadata is extracted from the mobile device, wherein the authentication metadata includes at least one metadata selected from a group of metadata including, but not limited to, a phone number and a MAC address. In accordance with the method herein described, the authentication metadata is pushed from the mobile device to a cloud element, wherein the authentication metadata is stored in an authentication metadata database within the cloud element. The mobile device is prompted to establish the real-time communications session with an authentication consumer. A query containing the real-time communications metadata from said real-time communications session with the authentication consumer is received within the cloud element, wherein the real-time communications metadata includes at least one metadata selected from a group of metadata including, but not limited to, a phone number and a MAC address. The real-time communications metadata is compared to the authentication metadata stored in the authentication metadata database. The method further includes retrieving, from the authentication metadata database, the authentication metadata related to the real-time communications metadata, and presenting a central authentication result to the authentication consumer, wherein the central authentication result indicates at least the mere presence of the authentication metadata within the authentication metadata database.

Alternative embodiments include a real-time communications session control system using local biometric authentication of a user via a mobile device to centrally authenticate the user and the mobile device to an authentication consumer during an incoming real-time communications session, and subsequent control of the real-time communications session. Such a real-time communications session control system includes an authentication application which is configured to: (1) initiate a local biometric authentication of the user by a biometric authentication system within the mobile device, wherein a user biometric data created by the biometric authentication system remains secret from the real-time communications session control system and within a biometric authentication system physical boundary at all times; (2) receive a user biometric metadata; (3) extract authentication metadata, wherein the authentication metadata includes at least one metadata selected from a group of metadata including, but not limited to, a phone number and a MAC address; (4) push the authentication metadata to a cloud element; and (5) prompt the mobile device to establish the real-time communication session with the authentication consumer. The cloud element is configured to: (1) store the authentication metadata; (2) receive a query containing a real-time communications metadata extracted from the real-time communications session with the authentication consumer, wherein the real-time communications includes at least one metadata selected from a group of metadata including, but not limited to, a phone number and a MAC address; (3) compare the real-time communications metadata to the authentication metadata; and (4) present a central authentication result to the authentication consumer. Furthermore, the authentication consumer is configured to: (1) extract the real-time communications metadata from the real-time communications session; (2) send a query containing the real-time communications metadata; (3) receive the central authentication result; (4) compare the central authentication result against a set of call access rules to determine appropriate actions to perform on the real-time communications session; and (5) perform at least one designated action on the real-time communications session.

Still further embodiments include a method using local biometric authentication of a user via a mobile device to centrally authenticate the user and the mobile device to an authentication consumer during an incoming real-time communications session, and subsequent control of the real-time communications session. Such a method may include: (1) initiating local biometric authentication of the user, wherein user biometric data created during the local biometric authentication of the user at all times remains secret from the method for controlling the real-time communications session; (2) receiving user biometric metadata from a biometric authentication system, wherein the user biometric metadata indicates a local authentication posture of the user; (3) extracting authentication metadata from the mobile device, wherein the authentication metadata includes at least one metadata selected from a group of metadata including, but not limited to, a phone number and a MAC address; (4) pushing the authentication metadata from the mobile device to a cloud element; (5) storing the authentication metadata in an authentication metadata database within the cloud element; (6) prompting the mobile device to establish the real-time communications session with an authentication consumer; (7) extracting real-time communications metadata from the real-time communications session with the authentication consumer, wherein the real-time communications metadata includes at least one metadata selected from a group of metadata including, but not limited to, a phone number and a MAC address; (8) receiving, within the cloud element, a query containing the real-time communications metadata from the real-time communications session with the authentication consumer; (9) comparing the real-time communications metadata to the authentication metadata stored in the authentication metadata database; (10) retrieving, from the authentication metadata database, the authentication metadata related to the real-time communications metadata; (11) presenting a central authentication result to the authentication consumer, wherein the central authentication result indicates at least the mere presence of the authentication metadata within the authentication metadata database; and (12) performing at least one action on the real-time communication session in accordance with a set of call access rules and based on the central authentication result.

### BRIEF DESCRIPTION OF THE DRAWINGS

FIG. 1 illustrates one embodiment of an authentication system 200 of the present disclosure wherein metadata extracted from a mobile device 202 is routed through the authentication system 200 metadata.

FIG. 2 shows a flow diagram illustrating an authentication process 700 for the real-time authentication systems shown and described.

FIG. 3 illustrates an alternative embodiment of a real-time communications session control system 600.

FIG. 4 shows a flow diagram illustrating a real-time communication session control process 800 for the real-time communication session control system 600.

FIG. 5 illustrates an alternative embodiment of a real-time authentication system 900.

### DETAILED DESCRIPTION OF PREFERRED EMBODIMENTS

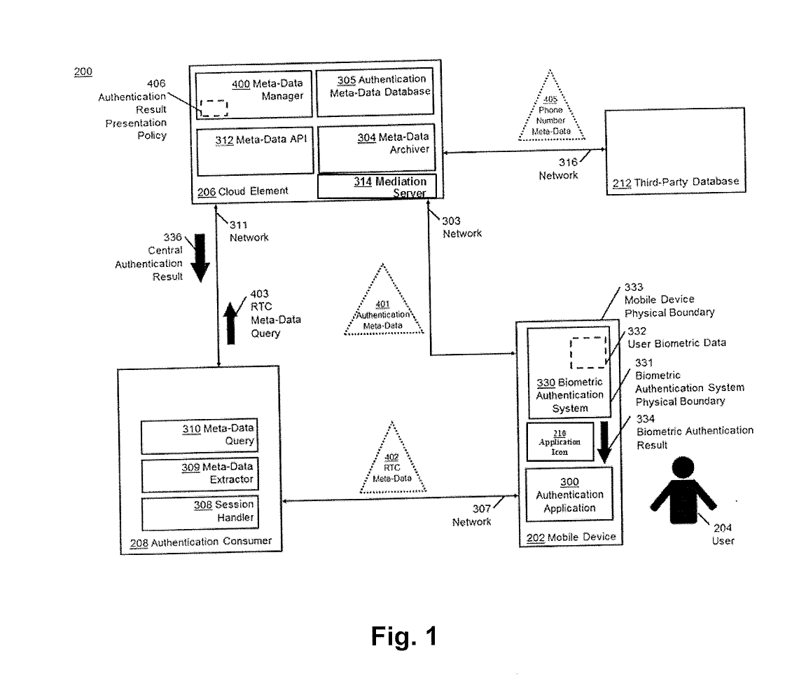

Referring to FIG. 1, an authentication system 200 generally includes an authentication application 300, a cloud element 206, a third-party database 212, a mobile device 202, and an authentication consumer 208. The authentication system 200 further includes a network 303, whereby the mobile device 202 and the cloud element 206 communicate; a network 307, whereby a user 204 and the mobile device 202 communicate with the authentication consumer 208; a network 311, whereby the cloud element 206 and the authentication consumer 208 communicate; and a network 316 whereby the cloud element 206 and the third-party database 212 communicate.

When supporting the real-time communications phone call (used herein as an example of the real-time communications session established by the mobile device), the network 307 is typically a radio-access network such as Global System for Mobiles (GSM) or Code Division Multiple Access (CDMA), and then transitions to an IP-based transport network such as IP Multimedia Subsystem (IMS) or Long-Term Evolution (LTE), until it reaches the private network of the authentication consumer 208. The composition of the network 307 will vary as necessary to support the specific type of real-time communications session established by the mobile device 202. The network 303 is typically a radio-access network and then transitions to an IP-based transport network such as IMS/LTE until it reaches the cloud element 206, which may be located in the public Internet or a private network. The network 311 can be a combination of a private network and public network transport until it reaches the cloud element 206, which may be located in the public Internet or on a private network. The network 316 may be a public network transport or a combination of a private network and public network transport until it reaches the cloud element 206, which may be located in the public Internet or on a private network.

In an alternate embodiment, the authentication system 200 includes the authentication application 300 and the cloud element 206.

The authentication application 300 is a downloadable application for the mobile device 202, which could be offered to the user 204 by the authentication consumer 208. The authentication application 300 may include authentication-consumer-specific configurations including, but not limited to:

(1) image and location of an authentication application icon 210 for initiating the authentication process 700 (e.g., the authentication application icon 210 may be located on the home screen of the mobile device 202, or within a downloadable authentication-consumer-specific application which provides one or more functionalities in addition to the authentication process 700, thereby requiring the user 204 to navigate within the authentication-consumer-specific application in order to access the authentication application icon 210);

(2) textual and/or audible messages to guide, inform, or prompt the user 204 during various stages of the authentication process 700 including, but not limited to, initial greeting, local biometric authentication, establishing the real-time communications session, welcome to the authentication consumer domain, and failed states of the authentication process 700;

(3) designated authentication application 300 actions responding to the authentication process 700 proceeding to failed states (e.g., authentication-consumer designated actions which the authentication application 300 executes if the user 204 fails local biometric authentication, and authentication-consumer designated actions if the mobile device 202 cannot establish the real-time communications session with the authentication consumer 208);

(4) designated contact information with which the authentication application 300 prompts the mobile device 202 to establish the real-time communications session with the authentication consumer 208; and

(5) designated authentication metadata 401 which the authentication application 300 extracts from the mobile device 202 hardware within and applications on the mobile device 202.

The cloud element 206 may be a combination of hardware and software, or software only, located in the public Internet or a private network. In preferred embodiments, cloud element 206 would include a mediation server 314 running on one or more physical or virtual servers. Preferably, mediation server 314 is a high availability component which processes events and places all such events in a database, as described in more detail below. Cloud element 206 is preferably integrated with one or more other components which function to carry out the authentication process. including, but not limited to, a metadata archiver 304, the authentication metadata database 305, a metadata manager 400, and a metadata Application Programming Interface (API) 312.

The metadata manager 400 includes an authentication result presentation policy 406, which is configurable to the requirements of the authentication consumer 208. The authentication result presentation policy 406 designates the method and policy for presenting a central authentication result 336 to the authentication consumer 208.

The authentication metadata 401 is a collocation of metadata extracted by the authentication application 300 from hardware within and applications on the mobile device 202. The authentication metadata 401 includes at least one metadata from a group of metadata including, but not limited to, the phone number, and unique hardware identifiers including, but not limited to, a MAC address, and metadata from applications on the mobile device 202 including, but not limited to, local time, and local temperature.

The authentication metadata 401 may further include the collocation of a phone number metadata 405 with the aforementioned metadata extracted by the authentication application 300. The phone number metadata 405 includes at least one metadata from a group of phone number-related metadata including, but not limited to, the Local Routing Number (LRN), Operating Company Number (OCN), Local Access and Transport Area (LATA), city, state, jurisdiction, Local Exchange Carrier (LEC), and linetype.

An RTC metadata 402 is metadata extracted from the real-time communications session between the mobile device 202 and the authentication consumer 208. The RTC metadata 402 includes at least one metadata from a group of metadata available during the real-time communications session including, but not limited to, the phone number, the MAC address, and additional metadata available during the specific form of real-time communications established by the mobile device 202 (e.g., phone call).

The third-party database 212 represents one or more third-party databases including, but not limited to a Local Number Portability (LNP) service. The third-party database 212 may be located in the public Internet or a private network.

The mobile device 202 is an electronic device including, but not limited to, a mobile phone, a smartphone, a pocket PC, and a handheld PC, wherein the electronic device includes a conventional local biometric authentication system associated with fingerprints, designated herein as a biometric authentication system 330. The biometric authentication system 330 issues a biometric authentication result 334.

The biometric authentication system physical boundary 331 defines the physical boundary within which the user biometric data 332 remains at all times.

The mobile device 202 further includes means for interacting with the network 303, and the network 307, and hosting the authentication application 300 of the present disclosure. The mobile device physical boundary 333 defines the interior physical surface of the mobile device 202.

The authentication consumer 208 is the recipient of the central authentication result 336 from the cloud element 206. The authentication consumer 208 is also the recipient of the real-time communications session initiated by the user 204 via the mobile device 202. The authentication consumer 208 may include, but is not limited to, any device or business entity that takes an action based on, provides a service based on, or otherwise benefits from (e.g., fraud prevention), knowing that a biometrically authenticated user is collocated with a SIM-identified or MAC-identified mobile device 202 during an incoming real-time communications session. The authentication consumer 208 may include, but is not limited to, a corporate call center, a corporation requiring employee authentication prior to allowing access to corporate files or resources, a 911 call center, a company that sends phones to customers requesting a replacement phone. The authentication consumer 208 may include a session handler 308, a metadata extractor 309, and a metadata query 310. The RTC metadata query 403 is a request for any known information related to the RTC metadata 402.

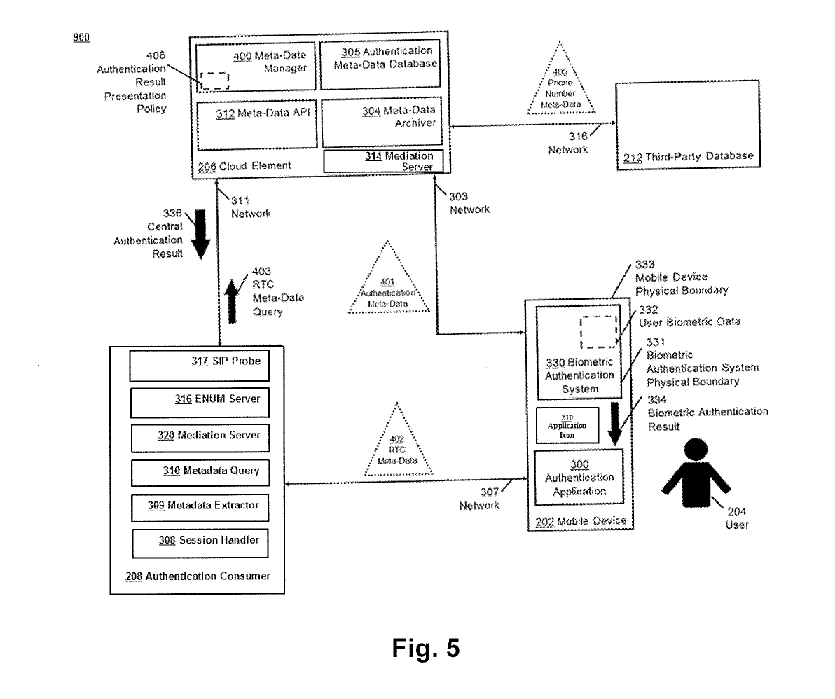

Authentication consumer 208 may further include an ENUM server 316, which when incorporated is preferably a highly reliable, redundant software application that gathers basic metadata (source number, destination number, time of day, etc.) from a Session Border Controller (SBC) (not shown) and also allows control of an incoming call, wherein control particularly includes the ability to allow, reroute or terminate the incoming call. Authentication consumer 208 may also include SIP probe 317. These components are described in more detail below with respect to the embodiment illustrated in FIG. 5.

The user 204 is a person who initiates the authentication process 700 for the purpose of obtaining authentication for, and initiating the real-time communications session with the authentication consumer 208. The user 204 may include, but is not limited to a customer, client, constituent, or employee of the authentication consumer 208, or of the owner of the authentication consumer 208, wherein the authentication consumer 208 is a device.

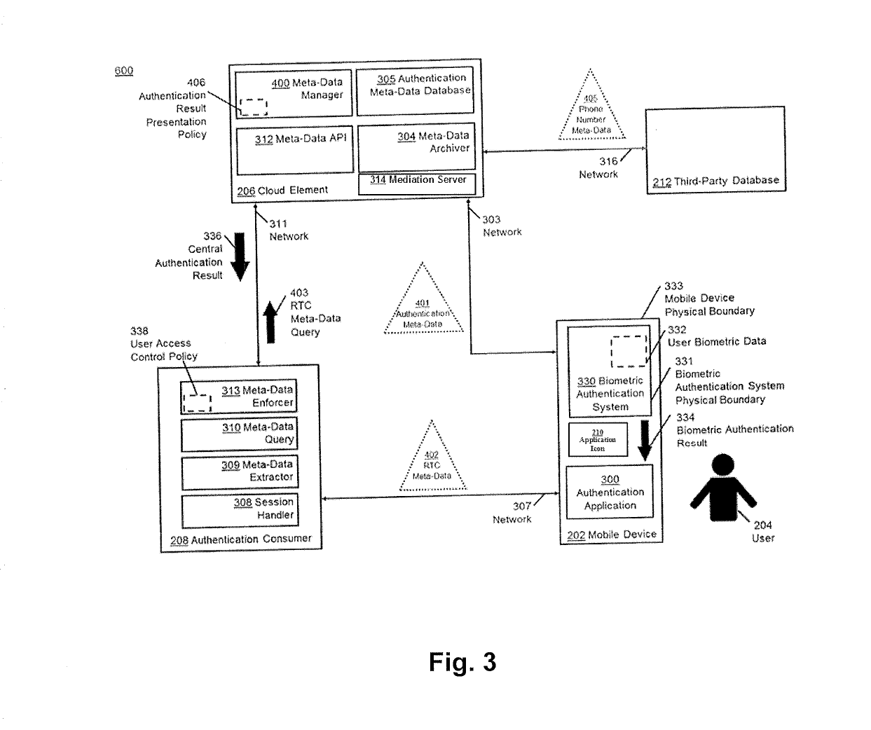

Referring now to FIG. 3, a real-time communications session control system 600 generally includes the components discussed previously with reference to the authentication system 200 of FIG. 1, plus a metadata enforcer 313 and a user access control policy 338 (each included in the authentication consumer 208). The user access control policy 338 is a set of call access rules, pre-defined by the authentication consumer 208 and specifying actions to be performed based upon the central authentication result 336.

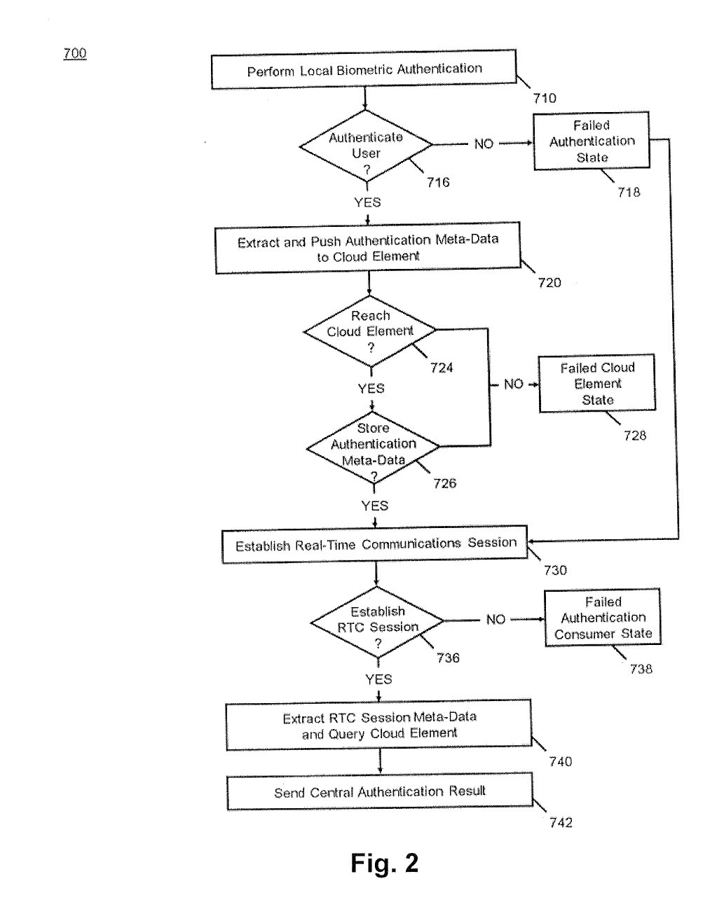

Referring now to FIG. 2, an authentication process 700 begins with step 710, when the user 204 touches the authentication application icon 210. The authentication application 300 prompts the biometric authentication system 330, which guides the user 204 through the local biometric authentication process. The biometric authentication system 330 takes biometric measurements of the physical characteristics of a finger of the user 204, creates the user biometric data 332, determines the local authentication posture of the user 204, and makes a biometric authentication result 334 available to the authentication application 300 in real-time. In preferred embodiments, when a user 204 launches authentication application 300, prompting a request for biometric data 332 for authentication purposes, this will cause mobile device ? to place a call for which authentication is required. In other embodiments, when user 204 launches a call to a destination number which requires authentication, then authentication application 300 will be launched, beginning the authentication process as herein described.

The biometric authentication result 334 is a Y/N (Yes/No) determination on the local authentication posture of the user 204 to the mobile device 202. The authentication process 700 maintains the localized privacy of the user biometric data 332 by using the biometric arbitration result 334 as user biometric metadata in subsequent steps, thereby allowing the user biometric data 332 to remain within the biometric authentication system physical boundary 331, and secret from the authentication application 300, and the authentication process 700 at all times.

In step 716, if the biometric authentication result 334 is negative, the user 204 fails authentication, and the authentication application 300 enters a failed authentication state in step 718, whereby the authentication application 300 skips steps 720, 724 and 726 and proceeds to step 730. Specifically, when the user 204 fails authentication in step 716, and step 720 is thereby skipped, ultimately in step 742 the authentication consumer 208 receives the central authentication result 336 containing a simple No answer regarding both the authentication of the user 204 and the presence of any authentication metadata 401 related to the query of step 740. Conversely, if the biometric authentication result 334 is positive, the user 204 is authenticated to the mobile device 202, and the authentication application 300 proceeds to step 720.

In step 720, the authentication application 300 extracts the authentication metadata 401 from the mobile device 202, and pushes the authentication metadata 401 to the metadata archiver 304 via the network 303. Essentially simultaneously with pushing authentication metadata 401 to metadata archiver 304, in preferred embodiments, authentication application 300 will make a RESTful (Representational Transfer State) API call to cloud element 206 which is then processed by mediation server 314. In alternative embodiments, cloud element 206 may be eliminated, and authentication metadata 401 may be pushed directly to authentication consumer ?.

In step 724, if the cloud element 206, or a redundant copy of the cloud element 206 cannot be reached, the authentication application 300 proceeds to a failed cloud element state in step 728, and the authentication process 700 terminates. Conversely, if the cloud element 206 is available to receive the authentication metadata 401, step 720 continues.

As step 720 continues, the metadata archiver 304 stores the authentication metadata 401 in the authentication metadata database 305. In accordance with the authentication result presentation policy 406, the metadata manager 400 may query the third-party database 212 for additional information related to the mobile device 202 phone number (contained within the authentication metadata 401). The metadata archiver 304 receives the phone number metadata 405 from the third-party database 212 and collocates the phone number metadata 405 with the existing metadata within the authentication metadata 401 in the authentication metadata database 305.

The metadata archiver 304 communicates the success or failure to store the authentication metadata 401 to the authentication application 300 in real time.

In step 726, if the metadata archiver 304 fails to store the authentication metadata 401, the authentication application 300 proceeds to the failed cloud element state in step 728, and the authentication process 700 terminates. Conversely, if the metadata archiver 304 successfully stores the authentication metadata 401 in the authentication metadata database 305, the authentication application 300 proceeds to step 730.

In step 730, the authentication application 300 prompts the mobile device 202 to establish the real-time communications session with the authentication consumer 208, via the network 307. The mobile device 202 brokers the underlying network interactions with the session handler 308. Real-Time Communications (RTC) encompasses all forms of communication wherein a user is in an active session with another user including, but not limited to, Short Message Service (SMS), phone calls, and over-the-top (OTT) content services including, but not limited to, Skype, and Facebook. Although real-time communications include many forms of communications, since the phone call is likely the most common and familiar form of real-time communications, the authentication process 700 is described herein using the phone call as an example of the real-time communications established by the mobile device 202.

In step 736, if the real-time communications session cannot be established with the authentication consumer 208, the authentication application 300 proceeds to a failed authentication consumer state in step 738, and the authentication application 300 does not declare the authentication process successful. Conversely, if the real-time communications session is successfully established, the authentication process 700 proceeds to step 740.

In step 740, the metadata extractor 309 understands the session in real-time, extracts the RTC metadata 402 from the session, and sends the RTC metadata 402 to the metadata query 310. The metadata query 310 sends an RTC metadata query 403 (requesting any known information related to the RTC metadata 402), to the metadata API 312 via the network 311, and awaits a response from the cloud element 206. The real-time communications session between the mobile device 202 and the authentication consumer 208 remains active throughout the subsequent steps.

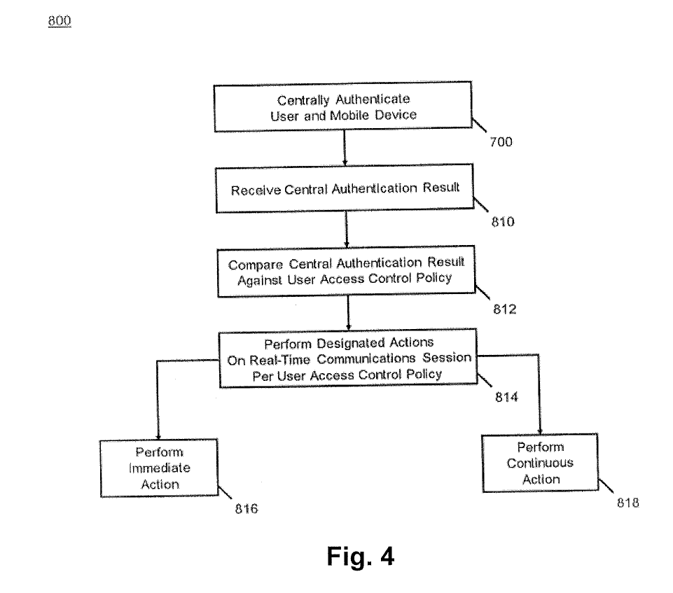

In step 742, the metadata API 312 retrieves information mapped to the authentication metadata 401 from the authentication metadata database 305, and accesses the authentication result presentation policy 406 to determine how the retrieved information should be presented to the authentication consumer 208. In one example, the metadata API 312 presents the central authentication result 336 as a simple [Yes/No] answer regarding the mere presence of the authentication metadata 401. The metadata API 312 presents the central authentication result 336 to the authentication consumer 208 via the network 311, thereby concluding the authentication process 700. Real-time communications session control actions taken by the authentication consumer 208 in response to the central authentication result 336 are discussed below with reference to the real-time communications session control process 800 of FIG. 4.

The authentication process 700 provides a seamless user experience for the user 204. Specifically, both steps 710 and 730 in which the user 204 (1) touches an icon to initiate the authentication process and the subsequent real-time communications session, and (2) interacts in the local biometric authentication process, are familiar operations for the user 204 of the mobile device 202 prior participating in the authentication process 700.

Further, the authentication process 700 provides a seamless user experience in that all steps and processes other than steps 710 and 730 (1) are transparent to the user 204, and (2) take place so quickly that the user 204 remains unaware that operations occur after the local biometric authentication process and before the user 204 becomes aware of the real-time communication session being established with the authentication consumer 208.

The authentication process 700 maintains the localized privacy of the user biometric data 332 by using the biometric arbitration result 334 as user biometric metadata, thereby allowing the user biometric data 332 to remain within the biometric authentication system physical boundary 331, and secret from the authentication application 300, and the authentication process 700 at all times.

Further, the authentication process 700 maintains the localized privacy of the user biometric data 332, since the cloud element 206 acts as a third party to broker the authentication process 700 between the user 204 and the mobile device 202, and the authentication consumer 208. By asynchronously communicating with the mobile device 202 and the authentication consumer 208, the cloud element 206 decouples authentication between the two parties, thereby maintaining the local privacy of a user biometric data 332 from the authentication consumer 208.

Referring now to FIG. 4, a real-time communications session control process 800 begins with step 700, wherein local biometric authentication of the user 204 via the mobile device 202 is used to centrally authenticate the user 204 and the mobile device 202 during an incoming real-time communications session, as discussed previously with reference to the authentication process 700 of FIG. 2.

In step 810, the metadata enforcer 313 receives the central authentication result 336 from the metadata API 312.

In step 812, the metadata enforcer 313 manages the response to the central authentication result 336. The metadata enforcer 313 compares the central authentication result 336 against the call access rules in the user access control policy 338 to determine appropriate actions to be performed on the real-time communications session from the user 204 and the mobile device 202.

In step 814, the metadata enforcer 313 performs actions on the real-time communications session in accordance with the user access control policy 338. In one example, the central authentication result 336 is a simple [Yes/No] answer regarding the mere presence of the authentication metadata 401 in a given temporal constraint, such as a time window from the present moment going back some number of time units. If the central authentication result 336 is negative, the user access control policy 338 may designate that the metadata enforcer 313 adjust its security posture to regard the mobile device 202 as “suspicious”. Conversely, if the central authentication result 336 is positive, the user access control policy 338 may designate that the metadata enforcer 313 adjust its security posture to regard the mobile device 202 as “authenticated”.

Further, the user access control policy 338 may dictate that the designated action performed by the metadata enforcer 313 be immediate, or continuous, as shown in steps 816 and 818, respectively. A continuous action persists for a pre-designated amount of time within the domain of the authentication consumer 208. For example, the security posture of the mobile device 202 may be propagated to multiple elements within the domain of the authentication consumer 208 for the purpose of allowing the mobile device 202 to stay connected to the domain without the need to provide further authentication.

The real-time communications session control process 800 provides a seamless user experience for the user 204, as discussed previously with reference to the authentication process 700 of FIG. 2.

The real-time communications session control process 800 maintains the localized privacy of the user biometric data 332, as discussed previously with reference to the authentication process 700 of FIG. 2.

Turning now to FIG. 5, there is illustrated an alternative embodiment of a real-time authentication system 900. In system 900, authentication consumer 208 is shown having mediation server 314, ENUM server 316, and Session Initial Protocol (SIP) probe 317. ENUM server 316 is preferably a highly reliable, redundant software application that gathers basic metadata and also allows control of whether to allow, reroute, or terminate a call. SIP probe 317 is preferably a passive software element which detects all SIP, Dual Tone Multi Frequency (DTMF), and potentially Real-time Transport Protocol (RTP) for incoming calls. In some embodiments, mediation server 314, ENUM server 316, and SIP probe 317 may be combined; however, in other embodiments, each of these components may be deployed on separate pieces of hardware.

In the operation of real-time authentication system 900, authentication consumer 208 receives an inbound authenticated call on a voice network. This inbound call itself likely has no authentication information associated with it. As a result, authentication consumer 208 will receive metadata associated with the inbound call from cloud element 206. In doing so, mediation server 320 uses a RESTful API call to receive metadata for the inbound call. This metadata could include any one or more of the source number, destination number, time of day, location, etc.

Following receipt of the metadata, mediation server 320 uses information from ENUM server 316 (source, destination, time of day, etc.) to correlate calls coming in to the inbound call, thus using the metadata received over a data network in order to authenticate an inbound call over a voice network. It will be understood that there may be hundreds of calls per second coming into the authentication consumer at any one time. Furthermore, the SIP probe 317 may extract information such as the location of the device if such information is passed by the service provider over the voice network.

Although not shown, it will be understood that cloud element 206 may incorporate elements such as ENUM server 316 and SIP probe 317, wherein such components would be employed and function in the same or similar manner as that describe herein with respect to their incorporation with authentication consumer 208.

In all respects, it should be understood that the drawings and detailed description herein are to be regarded in an illustrative rather than a restrictive manner, and are not intended to limit the invention to the particular forms and examples disclosed. Rather, the invention includes all embodiments and methods within the scope and spirit of the invention as claimed, as the claims may be amended, replaced or otherwise modified during the course of related prosecution. Any current, amended, or added claims should be interpreted to embrace all further modifications, changes, rearrangements, substitutions, alternatives, design choices, and embodiments that may be evident to those of skill in the art, whether now known or later discovered. In any case, all substantially equivalent systems, articles, and methods should be considered within the scope of the invention and, absent express indication otherwise, all structural or functional equivalents are anticipated to remain within the spirit and scope of the present inventive system and method. The invention covers all embodiments within the scope and spirit of such claims, irrespective of whether such embodiments have been remotely referenced here or whether all features of such embodiments are known at the time of this filing. Thus, the claims should be interpreted to embrace all further modifications, changes, rearrangements, substitutions, alternatives, design choices, and embodiments that may be evident to those of ordinary skill in the art.

We claim:

1. A system and method substantially as shown and described.
